(19) United States
(12) Patent Application Publication
(10) Pub. No.: US 2025/0110257 A1
(43) Pub. Date: Apr. 3, 2025

(54) SEE-THROUGH NEAR-EYE DISPLAY DEVICE WITH CRYSTALLINE WAVEGUIDE

(71) Applicant: Coherent, Inc., Santa Clara, CA (US)

(72) Inventor: Daniel Rytz, Wilmington, DE (US)

(21) Appl. No.: 18/829,087

(22) Filed: Sep. 9, 2024

Related U.S. Application Data
(60) Provisional application No. 63/542,034, filed on Oct. 2, 2023.

(51) Int. Cl. G02B 1/02; G02B 6/26; G02B 6/34; G02B 27/01

(52) U.S. Cl. CPC G02B 1/02; G02B 6/262; G02B 6/34; G02B 27/0172; G02B 2027/0178

(57) ABSTRACT

A see-through near-eye display device includes an image source configured to emit light conveying an image, a one-dimensional waveguide made of a crystalline material transmissive to visible light and arranged to receive and guide the light emitted by the image source, and a first grating disposed on or in the waveguide. The first grating is configured to couple out of the waveguide at least a portion of the light from the image source after having been guided by the waveguide to the first grating. Several particularly advantageous crystalline waveguide materials are disclosed, which exhibit a high refractive index and high transparency in the visible spectrum. In one class of embodiments, the crystalline waveguide material is based on a bismuth germanium oxide crystal or a bismuth silicon oxide crystal, optionally with substitutions and/or doping. The crystalline waveguide material may be of the form of Bi₁₂Ge_{1-x-y}SiₓTi_{y}O₂₀, with or without further dopants.

### TECHNICAL FIELD

The present disclosure relates in general to see-through near-eye display devices used in augmented reality (AR) glasses. The present disclosure relates in particular to waveguides used to relay the virtual content into a user's field of view (FOV).

### BACKGROUND

AR glasses superimpose electronically-generated virtual content on a real scene viewed by the user, thereby creating a hybrid visual experience containing both a real-scene image and a virtual image. Superimposing the virtual content on the real-scene image entails merging light conveying the virtual content into the path of the light from the real scene. For wide-spread user adoption, it is preferable that the user's view and perception of the real scene be augmented without being compromised. Widespread user adoption also requires that the AR glasses be aesthetically pleasing and, for example, look like regular eyeglasses. Furthermore, an immersive experience is desired, where the virtual image can be overlaid on a large portion of the user's FOV.

A pair of AR glasses includes one or two see-through near-eye display devices, one device for each eye or just a single device for either the left or the right eye. At a basic level, the see-through near-eye display device includes (a) a virtual-image source, for example a digital display device or a scanning laser projector, that emits light conveying the virtual image, and (b) relay-and-combination optics that relay the virtual-image-light into the user's FOV and deflect the virtual-image-light into the path of light propagating from the real scene toward the eye. Designing non-bulky relay-and-combination optics capable of creating large-FOV virtual images of high quality and with minimal degradation of the real-scene image is a challenging task critical to the user experience. One early-generation type of AR glasses suspended a prism in a corner of the user's FOV to deflect light from a digital display device toward the user's eye. The result was a virtual image overlayed on the real-scene image in a relatively peripheral location. The functionality was limited, and this type of AR glasses was not a commercial success.

Further limitations and disadvantages of conventional and traditional approaches will become apparent to one of skill in the art, through comparison of such systems with some aspects of the present disclosure as set forth in the remainder of the present application with reference to the drawings.

### SUMMARY OF THE DISCLOSURE

Waveguide-based see-through near-eye display devices are becoming a leading technology for providing a more immersive experience with improved see-through performance and packaging akin regular eyeglasses. In these waveguide-based devices, a one-dimensional waveguide relays the virtual-image-light into the user's FOV, and a grating disposed on the waveguide couples the virtual-image-light out of the waveguide toward the user's eye. The waveguide can be identical in shape to the lens of a regular pair of eyeglasses having zero optical power, and the virtual-image source can be integrated in the arm of the glasses. Waveguiding is based on total internal reflection. The waveguide material can therefore be transmissive to visible light from the real scene while functioning as a light conduit for visible light from the virtual-image source.

Disclosed herein is a waveguide-based see-through near-eye display device with a crystalline waveguide. The crystalline waveguide material has several potential advantages, including (a) high transparency throughout the visible spectrum, facilitating minimal dimming and minimal spectral distortion of the real-scene image together with low-loss conduction of the virtual-image light, (b) a high refractive index enabling the creation of large-FOV virtual images, (c) isotropic optical and mechanical properties ensuring high optical quality of both the real-scene image and the virtual image, and (d) high mechanical strength and hardness.

We have identified several crystalline materials that are particularly advantageous material choices for waveguides of the presently disclosed see-through near-eye display devices. These crystalline materials exhibit a high refractive index, e.g., 2.0 or more, throughout the visible spectrum. These materials also exhibit very low absorption throughout the visible spectrum. In one class of embodiments, the crystalline waveguide material is based on a bismuth germanium oxide crystal or a bismuth silicon oxide crystal, optionally with substitutions and/or doping. For example, the crystalline material may be of the form of Bi₁₂Ge_{1-x-y}SiₓTi_{y}O₂₀, with or without further dopants. In another class of embodiments, the crystalline waveguide material is based on cubic zirconia. In this class of embodiments, the crystalline material may be of the form (Zr₁₋ₓAₓ)O₂ with A being Ca or Y, with or without further dopants.

In one aspect of the disclosure, a see-through near-eye display device includes an image source configured to emit light conveying an image, a one-dimensional waveguide made of a crystalline material transmissive to visible light and arranged to receive and guide the light emitted by the image source, and a first grating disposed on or in the waveguide. The first grating is configured to couple out of the waveguide at least a portion of the light from the image source after having been guided by the waveguide to the first grating.

These and other advantages, aspects and novel features of the present disclosure, as well as details of an illustrated embodiment thereof, will be more fully understood from the following description and drawings.

### BRIEF DESCRIPTION OF THE DRAWINGS

The accompanying drawings, which are incorporated in and constitute a part of the specification, schematically illustrate embodiments of the present disclosure, and together with the general description given above and the detailed description of the embodiments given below, serve to explain principles of the present disclosure.

FIG. 1 illustrates a pair of AR glasses including two see-through near-eye display devices based on crystalline one-dimensional waveguides, according to an embodiment.

FIG. 2 shows a portion of a crystalline-waveguide-based see-through near-eye display device implementing two gratings for diffraction of virtual-image light into and out of the crystalline waveguide, according to an embodiment.

FIG. 3 schematically illustrates, in cross-sectional view, exemplary light propagation in a see-through near-eye display device based on a crystalline planar waveguide, according to an embodiment.

FIG. 4 is a cross-sectional view of another crystalline-waveguide-based see-through near-eye display device configured with a non-planar one-dimensional waveguide, according to an embodiment.

FIG. 5 plots the refractive index as a function of wavelength from 400 to 800 nanometers (nm) for certain crystalline materials that may form the crystalline waveguides of any see-through near-eye display devices of FIGS. 1-4.

### DETAILED DESCRIPTION OF THE DISCLOSURE

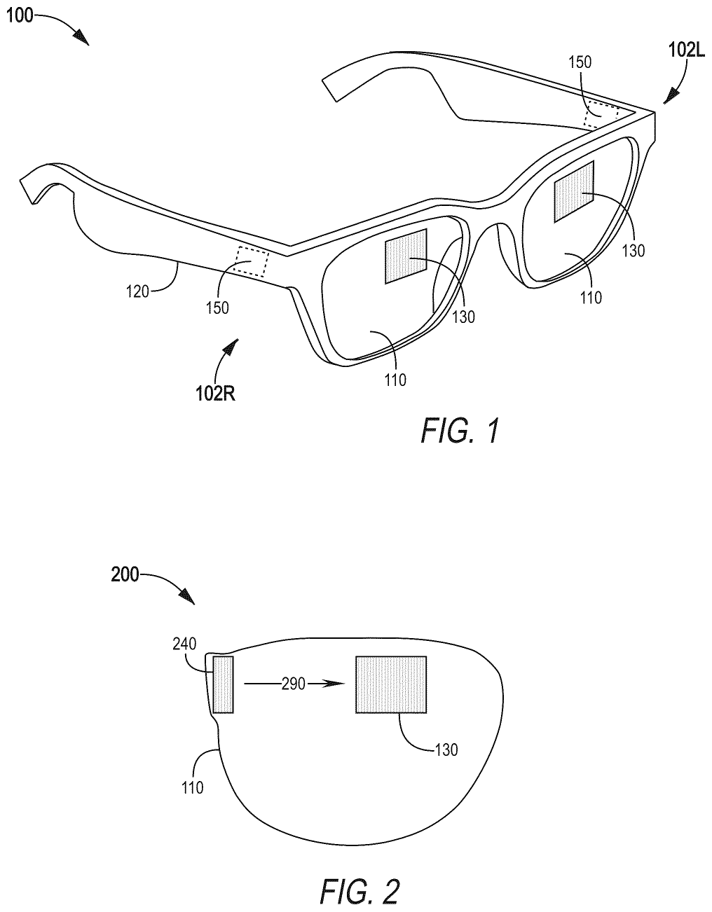

Referring now to the drawings, wherein like components are designated by like numerals, FIG. 1 illustrates one pair of AR glasses 100 including a left see-through near-eye display device 102L and a right see-through near-eye display device 102R, each based on a crystalline one-dimensional waveguide. Each of display devices 102L and 102R includes a waveguide 110 transmissive to visible light, a grating 130, and a virtual-image source 150. Virtual-image sources 150 may be integrated in a frame 120 of AR glasses 100. Virtual-image source 150 emits virtual-image light conveying a virtual image to be formed in an eye of the user. For this purpose, each virtual-image source 150 may include (a) a digital display configured with a collimation lens or (b) a scanning laser projector.

Waveguides 110 are incorporated into AR glasses 100 in the form of the left and right “lenses” thereof. Typically, the “lenses” formed by waveguides 110 have zero optical power. However, without departing from the scope hereof, one or both of waveguides 110 may have non-zero optical power, for example according to a user's ophthalmic prescription. Each waveguide 110 is a one-dimensional waveguide that confines guided light in one transverse dimension. In one example, each of waveguide 110 is a planar waveguide having two parallel planar surfaces. Light is guided in this planar waveguide through total internal reflection between the two parallel planar surfaces, provided that the propagation direction of the light is incident on the surfaces at an incidence angle that exceeds the critical angle for total internal reflection.

In operation, a user wears AR glasses 100 and views a real scene through AR glasses 100, that is, through the “lenses” formed by waveguides 110. More specifically, light from a real scene is transmitted by gratings 130 and waveguides 110, without being guided by waveguides 110. One or both of display devices 102L and 102R superimposes a virtual image on the real scene viewed by the user through AR glasses 100. In each of display devices 102L and 102R, this process entails light emitted by virtual-image source 150 being coupled into waveguide 110. Coupling of such virtual-image light into waveguide 110 may take place outside the user's FOV and/or in a location hidden by frame 120. Waveguide 110 then guides the virtual-image light to the location of grating 130. Grating 130 is disposed on or in waveguide 110. Grating 130 diffracts at least a portion of the virtual-image light out of waveguide 110 in the direction toward the user's eye, whereby a virtual image originating from virtual-image source 150 is superimposed on the real-scene image viewed by the user.

FIG. 2 shows a portion of one crystalline-waveguide-based see-through near-eye display device 200 implementing two gratings for diffraction of virtual-image light into and out of a crystalline one-dimensional waveguide. Display device 200 is an example of either one of display devices 102L and 102R of AR glasses 100. Display device 200 includes waveguide 110, grating 130, an additional grating 240, as well as virtual-image source 150 (not shown in FIG. 2). When display device 200 is implemented in AR glasses 100, grating 240 may be implemented in a portion of waveguide 110 that is hidden in frame 120.

In operation of display device 200, virtual-image light 290 from virtual-image source 150 is incident on waveguide 110 at the location of a grating 240. Grating 240 diffracts virtual-image light 290 into waveguide 110. Such in-coupled virtual-image light 290 propagates inside waveguide 110 at a propagation angle that exceeds the critical angle for total internal reflection at the surfaces of waveguide 110. Waveguide 110 then guides virtual-image light 290 to grating 130, whereupon grating 130 diffracts the guided virtual-image light 290 out of waveguide 110. Each of gratings 130 and 240 may be a surface relief grating or a holographic grating.

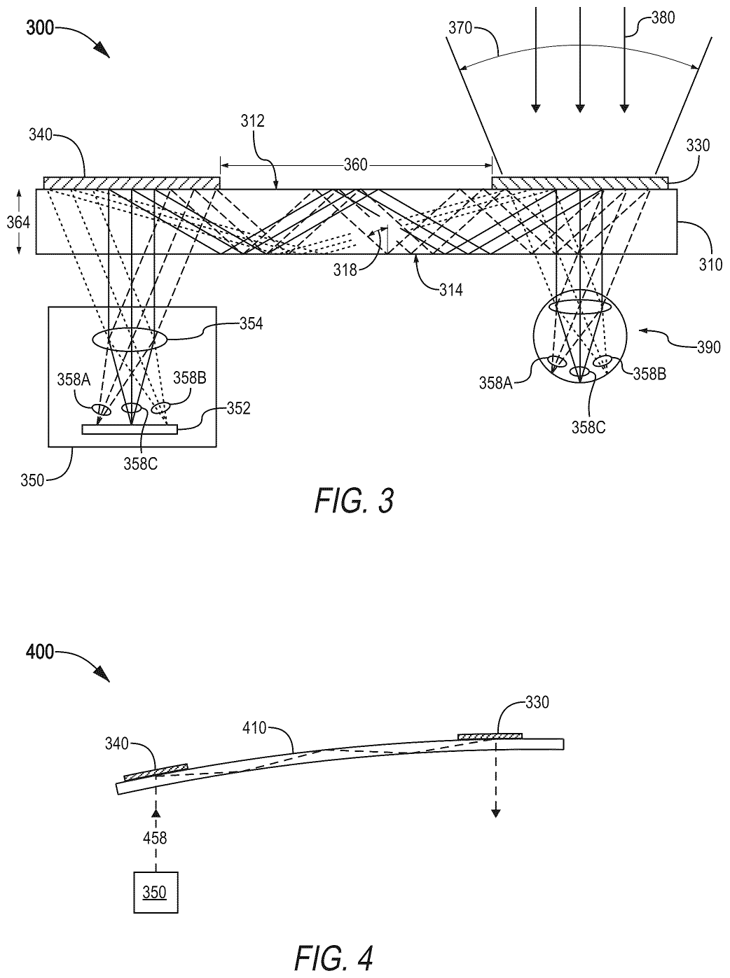

FIG. 3 illustrates, in cross-sectional view, exemplary light propagation in one see-through near-eye display device 300 based on a crystalline planar waveguide. In particular, FIG. 3 demonstrates, by example, the effect of the refractive index of the waveguide on the achievable FOV for the virtual image as perceived by the user. Display device 300 may be implemented in AR glasses 100 as either one of display devices 102L and 102R. Display device 300 includes a crystalline planar waveguide 310, gratings 330 and 340, and a virtual-image source 350.

Waveguide 310 has two planar surfaces 312 and 314 that cooperate to impose one-dimensional waveguiding through the mechanism of total internal reflection. The thickness 364 of waveguide 310 between surfaces 312 and 314 is, for example, in the range between 0.5 and 2 millimeters (mm). Gratings 330 and 340 may be similar to gratings 130 and 240, respectively, as discussed above in reference to FIG. 2. Gratings 340 and 330 are a non-zero distance 360 apart from each other. Distance 360 is, for example, in the range between 10 and 50 mm. FIG. 3 depicts an example where gratings 330 and 340 are located at surface 312 of waveguide 310, that is, at the surface of waveguide 310 facing away from a user's eye 390. Alternatively, one or both of gratings 330 and 340 may be located at surface 314 or embedded in waveguide 310. In the depicted embodiment, virtual-image source 350 and eye 390 are on the same side of waveguide 310. Alternatively, although typically not advantageous for packaging purposes, virtual-image source 350 and eye 390 may be on opposite sides of waveguide 310.

In operation, grating 340 diffracts light from virtual-image source 350 into waveguide 310, whereafter waveguide 310 guides this virtual-image light in the direction toward grating 330. Grating 330 then diffracts at least a portion of the guided virtual-image light toward eye 390. Diffraction of the guided virtual-image light toward eye 390 superimposes this virtual-image light on light 380 propagating toward eye 390 from a real scene.

In the embodiment shown in FIG. 3, virtual-image source 350 includes a digital display 352 and a collimation lens 354. Alternatively, virtual-image source 350 may be of a different form and, for example, include a scanning laser projector. In either case, virtual-image source 350 emits light having a range of propagation angles. In operation, display device 300 relays this virtual-image light to eye 390, where focusing of the virtual-image light by the eye 390 maps each propagation angle to a location on the retina of eye 390. In other words, image information is encoded in the propagation angles of the light emitted by virtual-image source 350.

For simplicity and without loss of generality, the following discussion of display device 300 assumes that virtual-image source 350 includes digital display 352 and collimation lens 354. In this embodiment, digital display 352 displays an image. Collimation lens 354 and the lens of eye 390 cooperate to form an imaging system that images the displayed image onto the retina of eye 390. The (de) magnification of this imaging system may be different from what is shown in FIG. 3. Consider three bundles of light rays originating from three different locations on digital display 352: a bundle 358C originating from the center of digital display 352, and two bundles 358A and 358B originating from two peripheral locations on digital display 352. Each of bundles 358A, 358B, and 358C is collimated by collimation lens 354. For each of bundles 358A, 358B, and 358C, FIG. 3 shows two outer rays and a central ray.

Grating 340 diffracts bundles 358A, 358B, and 358C to propagate in waveguide 310. Bundles 358A, 358B, and 358C are incident on surfaces 312 and 314 of waveguide 310 at three different respective angles of incidence with respect to normal vectors of surfaces 312 and 314. For each of bundles 358A, 358B, and 358C, the incidence angle on surfaces 312 and 314 exceeds the critical angle for total internal reflection, whereby waveguide 310 confines these ray bundles between surfaces 312 and 314. FIG. 3 indicates the incidence angle 318 for a selected ray of bundle 358A, which is the ray bundle incident on surfaces 312 and 314 closest to the critical angle for total internal reflection.

Although not shown in FIG. 3, a portion of the light emitted by virtual-image source 350 may be diffracted by grating 340 to propagate in waveguide 310 at angles that are less than the critical angle for total internal reflection. Such light will not undergo total internal reflection and therefore will not be guided by waveguide 310. Such light may be considered lost and is ignored in the present discussion. In the interest of minimizing generation of stray light, however, it may be preferable to configure virtual-image source 350 to only emit rays that are guided by waveguide 310 from grating 340 to grating 330.

The virtual image generated on the retina of eye 390 from the light originating from virtual-image source 350 spans a FOV angle 370. FOV angle 370 is limited by the range of permissible propagation angles of light guided in waveguide 310. This is evident from FIG. 3, where FOV angle 370 is defined by the difference in propagation angle between collimated rays of bundle 358A and collimated rays of bundle 358B. While it is possible to increase the difference in propagation angle between collimated rays of bundles 358A and bundle 358B emitted by virtual-image source 350, these rays are only guided by waveguide 310 if propagating at angles greater than the critical angle for total internal reflection. As drawn, bundle 358A is incident on surfaces 312 and 314 at the smallest angle of incidence, thus closer to the critical angle than bundles 358B and 358C. Extending FOV angle 370 will require reducing the angle of incidence of bundle 358A, but the critical angle for total internal reflection limits how much this incidence angle can be reduced (if at all). However, the critical angle for total internal reflection is a decreasing function of the refractive index of waveguide 310. It follows that embodiments of waveguide 310 having a relatively high refractive index are capable of guiding light incident on surfaces 312 and 314 at relatively small incidence angles, thereby allowing for a relatively large FOV angle 370.

FIG. 4 is a cross-sectional view of another crystalline-waveguide-based see-through near-eye display device 400 configured with a non-planar one-dimensional waveguide. Display device 400 is similar to display device 300 except for implementing a curved one-dimensional waveguide 410 instead of planar waveguide 310. Waveguide 410 may be a curved “lens” (with or without optical power) of a pair of AR glasses, such as AR glasses 100. Despite being curved, waveguide 410 still guides light that is incident on the surfaces of waveguide 410 at incidence angles greater than the critical angle for total internal reflection. Light propagation in display device 400 is illustrated schematically by a single ray 458. The discussion of light propagation in display device 300 is readily extendable to display device 400. As is the case for display device 300, the achievable field-of-view for the generated virtual images in display device 400 is limited by the critical angle for total internal reflection.

The above discussion of light propagation in the display devices 300 and 400 demonstrates that a high refractive index of the waveguide material allows for creating large-FOV virtual images in waveguide-based see-through near-eye display devices. Additionally, as is evident from FIG. 3, a high refractive index of the waveguide material allows for positioning the virtual-image source closer to the waveguide, which may be beneficial for packaging purposes.

Certain crystalline materials are advantageous material choices for the waveguide in a waveguide-based see-through near-eye display device, such as any of waveguides 110, 310, and 410. For optimal optical properties, the crystalline waveguide may be made of a single crystal. In one embodiment, the waveguide is made of a crystalline material having a refractive index of at least 2.0 throughout the wavelength range from 430 to 760 nanometers (nm) or throughout the wavelength range from 400 to 800 nm, so as to facilitate the creation of large-FOV virtual images. For the purposes of low-loss waveguiding of the virtual-image light and transmission of real-scene light with minimal dimming and minimal spectral distortion, the crystalline material may be characterized by a low absorption coefficient in the visible spectrum. For example, the absorption coefficient may be less than 2.0 cm⁻¹ or even less than 1.0 cm⁻¹ throughout the wavelength range from 430 to 760 nm or throughout the wavelength range from 400 to 800 nm.

Two classes of material compositions have been identified as exhibiting both high refractive indices and low absorption in the visible spectrum, in accordance with the specifications stated above, namely so-called BGO/BSO-based crystals and cubic zirconia. The class of BGO/BSO-based crystals includes crystals based on bismuth, germanium, and oxygen and crystals based on bismuth, silicon, and oxygen. BGO/BSO-based crystals of the form Bi₁₂Ge_{1-x-y}SiₓTi_{y}O₂₀, wherein 0≤x≤1 and 0≤y≤0.2, have particularly favorable properties. Each of the BGO/BSO-based crystals may further be doped with boron, aluminum, gallium, and/or indium. The molar dopant concentration may be up to 5%, for example in the range between 0.5% and 5%. Doping may help improve optical properties such as absorption, and boron and/or aluminum doping is expected to yield the best results. Cubic zirconia crystals typically include Y₂O₃ or CaO in order to stabilize the cubic structure. The cubic zirconia crystals may thus be of the form (Zr₁₋ₓAₓ)O₂, wherein A is yttrium or calcium. Optionally, the cubic zirconia crystals contain further dopants. Y₂O₃ may be added at a molar concentration of 10-25%, and CaO may be added at a molar concentration of 5-20%.

BGO/BSO-based crystals may be grown using growth procedures known in the art, such as Czochralski, Bridgman, or hydrothermal growth. Cubic zirconia crystals may be grown by skull melting. Dopants and substitutions, as discussed above, may be present from the beginning of the growth process. The crystals may be grown with high purity, for example at least 99.995% purity, in order to ensure low absorption. Additionally, when dopants are included, the growth process may be optimized for homogenization of dopants. Homogenization of dopants improve the optical quality of the crystals. The crystals may be stoichiometric or non-stoichiometric. For example, doped or undoped BGO/BSO-based crystals may contain an excess of bismuth. In the case of Bi₁₂Ge_{1-x-y}SiₓTi_{y}O₂₀, the starting mixture used for crystal growth may be 6 Bi₂O₃+(1+t)[(1-x-y)GeO₂+xSiO₂+yTiO₂], wherein 0≤t≤0.15 or, more particularly, 0≤t≤0.07. This mixture may further contain additional dopants. The crystals may be grown in cuboidal or cylindrical form. In the case of cylindrical crystals, the crystals may be slightly faceted due to the crystalline structure, and the crystals may have a diameter that exceeds 160 mm. Sawing, milling, boring, grinding, and/or polishing may be utilized to cut waveguides out of the grown crystals.

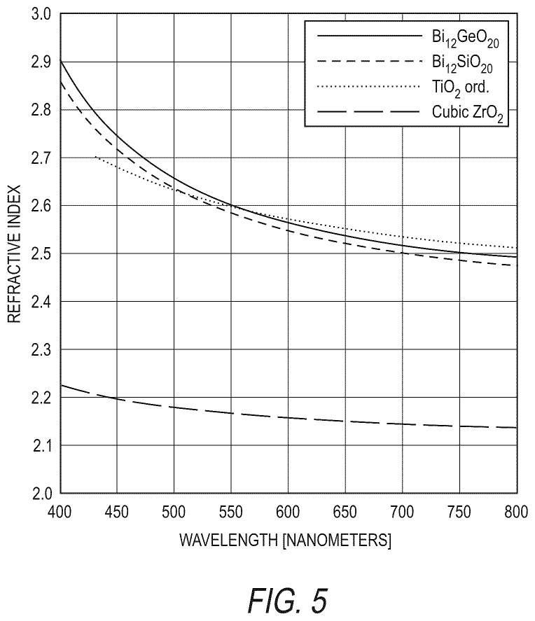

FIG. 5 plots the refractive index as a function of wavelength from 400 to 800 nanometers (nm) for certain ones of the crystalline waveguide materials discussed above: a BGO crystal Bi₁₂GeO₂₀, a BSO crystal Bi₁₂SiO₂₀, and a cubic zirconia crystal ZrO₂. Each of these materials have a high refractive index that exceeds 2.0 throughout the range between 400 and 800 nm. Bi₁₂GeO₂₀ and Bi₁₂SiO₂₀ have particularly high refractive indices, approximately 2.5 and higher throughout the range from 400 to 800 nm. For comparison, FIG. 5 also plots the ordinary refractive index for a titanium dioxide crystal TiO₂. The ordinary refractive index of TiO₂ is comparable to those of Bi₁₂GeO₂₀ and Bi₁₂SiO₂₀.

Based on their refractive indices, all the crystal compositions of FIG. 5 are good waveguiding materials that can facilitate the creation of large-FOV virtual images in waveguide-based see-through near-eye display devices. However, TiO₂ exhibits significantly higher absorption in the visible spectrum than Bi₁₂GeO₂₀, Bi₁₂SiO₂₀, and cubic zirconia, at least when these latter crystals are manufactured with high purity. TiO₂ is therefore less desirable. Bi₁₂GeO₂₀, Bi₁₂SiO₂₀, and cubic zirconia will all guide the virtual-image light more with very little loss and transmit the real-scene light with minimal loss and minimal spectral distortion.

In addition to having high refractive indices and low absorption, the BGO/BSO-based crystals and cubic zirconia may have highly isotropic optical and mechanical properties, high mechanical strength, and hardness suitable for waveguide manufacture and use.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry, a component or a device is “operable” to perform a function whenever the circuitry, component or device comprises the necessary hardware and code (if any is necessary) or other elements to perform the function, regardless of whether performance of the function is disabled or not enabled (e.g., by a user-configurable setting, factory trim, configuration, etc.).

The present disclosure is described above in terms of multiple embodiments. The invention is not necessarily limited, however, to the embodiments described and depicted herein. Rather, the invention is limited only by the claims appended hereto.

What is claimed is:

1. A see-through near-eye display device, comprising:
an image source configured to emit light conveying an image;
a one-dimensional waveguide made of a crystalline material transmissive to visible light and arranged to receive and guide the light emitted by the image source;
a first grating disposed on or in the waveguide, the first grating being configured to couple out of the waveguide at least a portion of the light from the image source after having been guided by the waveguide to the first grating.

2. The device of claim 1, wherein the crystalline material is a single crystal.

3. The device of claim 2, wherein the single crystal contains bismuth, germanium, and oxygen.

4. The device of claim 2, wherein the single crystal is a doped or undoped Bi₁₂Ge_{1-x-y}SiₓTi_{y}O₂₀ crystal, wherein 0≤x≤1 and 0≤y≤0.2.

5. The device of claim 4, wherein the Bi₁₂Ge_{1-x-y}SiₓTi_{y}O₂₀ crystal is doped with one or more of boron, aluminum, gallium, and indium.

6. The device of claim 4, wherein the Bi₁₂Ge_{1-x-y}SiₓTi_{y}O₂₀ crystal is doped exclusively with one or both of boron and aluminum.

7. The device of claim 5, wherein the Bi₁₂Ge_{1-x-y}SiₓTi_{y}O₂₀ crystal is characterized by a dopant concentration of less than 5%.

8. The device of claim 2, wherein the single crystal is doped or undoped Bi₁₂GeO₂₀.

9. The device of claim 2, wherein the single crystal is doped or undoped Bi₁₂SiO₂₀.

10. The device of claim 2, wherein the single crystal is cubic zirconia.

11. The device of claim 2, wherein the single crystal is cubic zirconia stabilized with Y₂O₃.

12. The device of claim 2, wherein the single crystal is cubic zirconia stabilized with CaO.

13. The device of claim 1, wherein the crystalline material has a refractive index of at least 2.0 throughout a wavelength range from 430 to 760 nanometers.

14. The device of claim 13, wherein the crystalline material has an absorption coefficient of less than 1 cm⁻¹ throughout the wavelength range from 430 to 760 nanometers.

15. The device of claim 1, wherein the crystalline material has a refractive index of at least 2.0 throughout a wavelength range from 400 to 800 nanometers.

16. The device of claim 15, wherein the crystalline material has an absorption coefficient of less than 1 cm⁻¹ throughout a wavelength range from 400 to 800 nanometers.

17. The device of claim 1, wherein the waveguide has first and second surfaces facing away from each other, and total internal reflection of the light at the first and second surfaces results in one-dimensional waveguiding of the light.

18. The device of claim 17, wherein the first grating is at one of the first and second surfaces.

19. The device of claim 1, further comprising a second grating disposed on or in the waveguide, the second grating being configured to couple the light into the waveguide from the image source, such that the light is guided by the waveguide to the first grating.

20. The device of claim 19, wherein the first and second gratings are a non-zero distance apart from each other.
